(19) United States
(12) Patent Application Publication
(10) Pub. No.: US 2016/0327729 A1
(43) Pub. Date: Nov. 10, 2016

(54) TRANSPARENT DISPLAY DEVICE

(71) Applicant: Taptl, LLC, Miami, FL (US)

(72) Inventors: Jeremiah Patterson, Satellite Beach, FL (US); Mary Wolff, Miami, FL (US)

(21) Appl. No.: 15/147,982

(22) Filed: May 6, 2016

Related U.S. Application Data
(60) Provisional application No. 62/158,070, filed on May 7, 2015.
(60) Provisional application No. 62/237,386, filed on Oct. 5, 2015.
(60) Provisional application No. 62/237,388, filed on Oct. 5, 2015.

(51) Int. Cl. F21V 8/00; G06F 3/044; G06F 3/042

(52) U.S. Cl. CPC G02B 6/0063; G06F 3/0428; G06F 3/044

(57) ABSTRACT

The present disclosure provides a transparent display. The transparent display includes a first layer including a display module, a second layer including a light guide panel configured to transmit light through the display module to generate viewable content, and a third layer including a tinted material, wherein the second layer is positioned between the first layer and the third layer, and wherein the tinted material enables a user to view the viewable content when looking through the third layer toward the first and second layers.

### CROSS REFERENCE TO RELATED APPLICATIONS

This application claims priority to U.S. Provisional Patent Application No. 62/158,070, filed on May 7, 2015, U.S. Provisional Patent Application No. 62/237,386, filed on Oct. 5, 2015, and U.S. Provisional Patent Application No. 62/237,388, filed on Oct. 5, 2015, the entire disclosures of which are hereby incorporated by reference in their entirety.

### FIELD OF THE DISCLOSURE

The present disclosure relates generally to display devices, and more particularly, to a transparent display on which content is viewable from both sides of the display.

### BACKGROUND

Display technology is used in a variety of devices (e.g., portable electronics, computing devices, televisions, medical devices etc.) to generate and display content to a user. The displayed content may include text and/or images and may be interactive (e.g., a user interface displayed on a computing device) or non-interactive (e.g., predetermined programming displayed on a television). Accordingly, there is a strong desire to improve both functional and aesthetic aspects of display technology systems.

### BRIEF DESCRIPTION OF THE DISCLOSURE

In one embodiment, a transparent display is provided. The transparent display includes a first layer including a display module, a second layer including a light guide panel configured to transmit light through the display module to generate viewable content, and a third layer including a tinted material, wherein the second layer is positioned between the first layer and the third layer, and wherein the tinted material enables a user to view the viewable content when looking through the third layer toward the first and second layers.

In another embodiment, a transparent display system is provided. The transparent display system includes a transparent display including a first layer having a display module, a second layer having a light guide panel configured to transmit light through the display module to generate viewable content, and a third layer having a tinted material, wherein the second layer is positioned between the first layer and the third layer, and wherein the tinted material enables a user to view the viewable content when looking through the third layer toward the first and second layers. The transparent display system further includes a frame housing the transparent display, and a base coupled to and supporting the frame.

In yet another embodiment, a method of assembling a transparent display is provided. The method includes coupling a first layer to a second layer, wherein the first layer includes a display module, and wherein the second layer includes a light guide panel configured to transmit light through the display module to generate viewable content, and positioning a third layer relative to the second layer such that the second layer is positioned between the first and third layers, wherein the third layer includes a tinted material, and wherein the tinted material enables a user to view the viewable content when looking through the third layer toward the first and second layers.

### BRIEF DESCRIPTION OF THE DRAWINGS

FIG. 1 is a schematic diagram of one embodiment of a transparent display.

FIG. 2 is a schematic diagram of another embodiment of a transparent display.

FIG. 3 is a schematic diagram of another embodiment of a transparent display.

FIG. 4 is a schematic diagram of another embodiment of a transparent display.

FIG. 5 is a schematic diagram of another embodiment of a transparent display.

FIG. 6 is a schematic diagram illustrating visibility and touch capability for the transparent display shown in FIG. 5.

FIG. 7 is a schematic diagram of another embodiment of a transparent display.

FIG. 8 is a schematic diagram of another embodiment of a transparent display.

FIG. 9 is a schematic diagram of another embodiment of a transparent display.

FIG. 10 is a schematic diagram of another embodiment of a transparent display.

FIG. 11 is a schematic diagram illustrating visibility and touch capability for the transparent display shown in FIG. 7.

FIG. 12 is a front view of one embodiment of a transparent display system.

FIG. 13 is a side view of the transparent display system shown in FIG. 12.

FIG. 14 is a block diagram of one embodiment of a system architecture of a transparent display system.

FIG. 15 is a front view of one embodiment of a transparent display system installed in window mullions.

FIG. 16 is a top view of the transparent display system shown in FIG. 15.

FIG. 17 is a top view of the window mullions shown in FIG. 15.

### DETAILED DESCRIPTION OF THE DISCLOSURE

The systems and methods described herein provide a transparent display. The transparent display includes a first layer including a display module, a second layer including a light guide panel configured to transmit light through the display module to generate viewable content, and a third layer including a tinted material, wherein the second layer is positioned between the first layer and the third layer, and wherein the tinted material enables a user to view the viewable content when looking through the third layer toward the first and second layers. The transparent display may also include layers including touch sensors and/or modules including additional display modules.

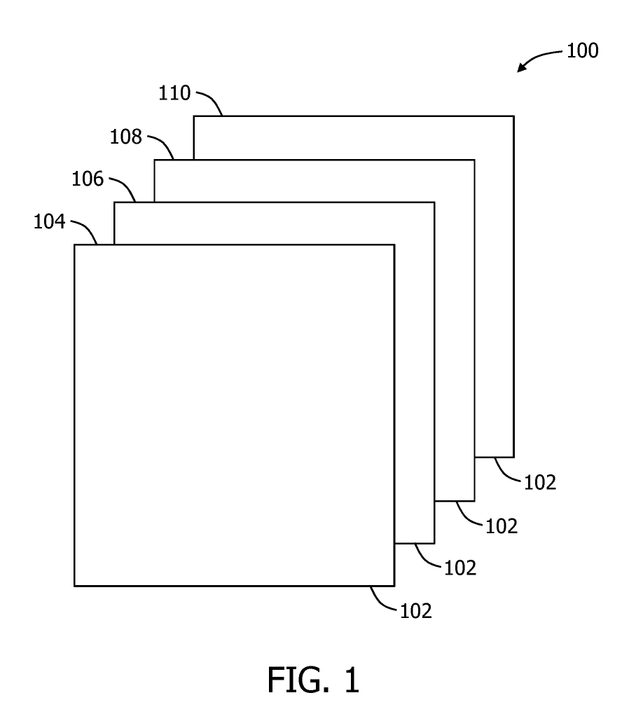

FIG. 1 is a schematic diagram of one embodiment of a transparent display 100. Transparent display 100 includes a plurality of layers 102. In the embodiment shown in FIG. 1, transparent display 100 includes four layers 102. Alternatively, transparent display 100 may include any number of layers 102.

In this embodiment, a first, front, or forward-most layer 104 is substantially transparent. For example, first layer 104 may be substantially transparent protective glass, poly-carbonate, or acrylic. First layer 104 may also include touch capability, as described herein. For example, first layer 104 may include an infrared (IR) frame/bezel that includes IR touch capability embedded therein. Contained in the bezel are IR light emitting diodes (LEDs) and/or at least one optical camera that interpret disruption of a light-field generated by the display as a “touch”. Alternatively, first layer 104 may include any touchscreen technology that enables transparent display 100 to function as described herein.

For example, in some embodiments, first layer 104 includes a projected capacitive (PCAP) component with PCAP touch capability embedded therein. The PCAP component may include a film embedded into, or applied onto, protective glass of first layer 104. Alternatively, the PCAP component may incorporate any suitable PCAP technology. In some embodiments, first layer 104 does not include a touch sensor and/or touch capability. Further, in some embodiments, transparent display 100 does not include first layer 104 at all.

In this embodiment, a second layer 106 of transparent display 100 is a transparent liquid crystal display (LCD) module. The LCD module is semi-transparent in appearance. Specifically, when light is transmitted through the LCD module, ‘white’ colors appear transparent or semi-transparent and ‘black’ colors appear opaque. By transmitting light through the LCD module, viewable content is generated on transparent display 100. Although second layer 106 is an LCD module in this embodiment, in alternative embodiments, second layer 106 may use any suitable display technology, including, but not limited to, LED lights, organic light-emitting diodes (OLEDs), active matrix organic light-emitting diodes (AMOLEDs), quantum dot light-emitting diodes (QLEDs), a quantum liquid crystal display (QLCD), quantum organic light-emitting diodes (QOLEDs), transparent organic light-diodes (TOLEDs), and/or passive matrix organic light-emitting diodes (PMOLEDs).

A third layer 108 of transparent display 100 is a transparent, semi-transparent, or translucent piece of poly-carbonate, acrylic, plastic, glass, gel, or another similar substrate. Third layer 108 functions as a light guide panel (LGP) that facilitates illuminating the LCD module of second layer 106.

In this embodiment, a fourth layer 110 of transparent display 100 is a protective hardening coating applied to third layer 108. Fourth layer 110 may be, for example, a piece of protective glass, poly-carbonate, acrylic, or other hardened substrate that facilitate providing protection for the rear of transparent display 100. In this embodiment, fourth layer 110 includes a film or inherent layer that is tinted by 35% or more via any number of techniques, including, but not limited to, frosting, darkening, or other similar means of light obstruction. This tinting effects mitigates the glow coming from the backlighting effect generated by the LGP of third layer 108, allowing viewable content displayed by transmitting light through the LCD module of second layer 106 to be viewed from both directions (i.e., from the front and from the back of transparent display 100). In some embodiments, similar to first layer 104, fourth layer 110 may also include touchscreen technology.

Layers 102 are protected and encased in a surrounding frame (not shown in FIG. 1) in this embodiment. Alternatively, some embodiments (e.g., embodiments using OLEDs and/or QLEDs) may not include a frame. The frame may be made from, for example, aluminum, steel, carbon fiber, polycarbonate, and/or any other material that encases and forms a durable frame to keep all the layers together. The frame may include different inputs, such as a high-definition multimedia interface (HDMI) input, a display port, a universal serial bus (USB) input, a speaker input, an optical audio input, a component audio input, and/or one or more power outlets, receivers, or ancillary power requirements or I/O. The frame may also include, for example, a Wifi radio, a Bluetooth radio, Beacon technology (e.g., iBeacon), a near field communication (NFC) module, an internal media player, an internal media converter, a hard drive, a solid state drive, a motherboard, RAM, video card(s), sound/audio card(s), a power inverter, a power receiver, a power supply, an automated lighting or other automated adjustment component (e.g., a sensor that detects ambient light and adjusts a brightness of the displayed content automatically), and/or a manual lighting or other manual adjustment component.

Surrounding an inner part of the frame, on one, two, three, or four sides, are LED lights. The LED lights provide the necessary lighting to illuminate the LGP of third layer 108 and transmit light through the display module of second layer 106. The LED lights used may vary based on the use and presentation of transparent display 100, and may be embedded using an LED strip, or using individual LEDs aligned on the inside of the frame. In some embodiments, instead of LED lights, OLEDs, AMOLEDs, QLEDs, a QLCD, QOLEDs, TOLEDs, and/or PMOLEDs are utilized.

In some embodiments, content displayed on a transparent display is visible and interactive for users on both sides of the transparent display. That is, the transparent display may include a panel with touchscreen capability on both the front and back, such that a first user (“User 1”) facing the device can see through the device while manipulating a first touch screen to control what is displayed, and a second user (“User 2”) on the opposite side of the device can see through the device and can manipulate a second touch screen to control what is displayed. In other embodiments, users on both sides may be able to view displayed content, but only one side of the display device includes touchscreen technology for manipulating the displayed content.

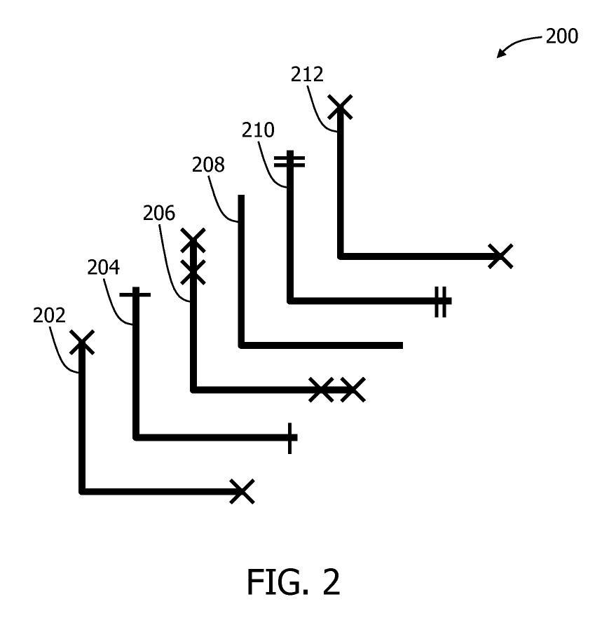

FIG. 2 is a schematic diagram of a transparent display 200 for which content is viewable and interactive from both sides. That is, both the front and back of transparent display 200 include touchscreen technology. For clarity and simplicity, only the corner of each layer of transparent display 200 is shown in FIG. 2. However, those of skill in the art will appreciate that the layers of transparent display 200 will be complete panels, and may have any suitable shape (e.g., rectangular, circular, hexagonal, etc.). Further, transparent display 200 may be made of a flexible and/or bendable material.

Transparent display 200 includes a first layer 202 that includes one or more touch sensors. In this embodiment, first layer 202 is implemented using infrared (IR) touch sensors. The touch sensors may be single-point or multi-point touch sensors Alternatively, first layer 202 may be implemented using other touchscreen technology (e.g., PCAP or silver nanowire technology, and/or surface light wave (SLW) technology). A second layer 204 of transparent display 200 is a protective layer. For example, second layer 204 may be a glass or film layer. The touch sensors of first layer 202 may be affixed to second layer 204 using, for example, optical bonding or lamination. In some embodiments, first and second layers 202 and 204 are switched, such that the touch sensors are located behind (instead of in front of) the protective layer. Notably, the touch sensors still detect when a user touches the protective layer instead of the touch sensors directly.

Transparent display 200 includes a third layer 206 that functions as a display layer. Third layer 206 may be, for example, an LED OLED, AMOLED, QLED, QLCD, QOLED, TOLED, PMOLED, and/or QLED display. Alternatively, third layer 206 may be any suitable display technology that enables transparent display 200 to function as described herein. Third layer 206 may be attached to second layer 204 using, for example, optical bonding. Alternatively, third layer 206 may merely be positioned close to (e.g., within 3 millimeters (mm) of) second layer 204.

A fourth layer 208 of transparent display 200 is a transparent light guide in this embodiment. The transparent light guide may be, for example, a polymer. In some embodiments, the transparent light guide includes a light diffusing tape or film to ensure a uniform distribution of light. Fourth layer 208 may be closely positioned (e.g., within 3 mm) or optically bonded to third layer 206.

A fifth layer 210 including a tinted glass or film is bonded to fourth layer 208 opposite third layer 206 in this embodiment. For example, fifth layer 210 may have a grey or bronze tint, and may be tinted greater than or equal to 30% to enhance two-way visibility of transparent display 200 and reduce the perceived brightness of the light guide of fourth layer 208. The tinting is useful when the LEDs are bright enough to scatter light through the light guide, which may create an undesirable glow that may affect transparency.

Similar to first layer 202, a sixth layer 212 of transparent display 200 includes IR touch sensors. Accordingly, first and sixth layers 202 and 212 provide touch sensors on both the front and back of transparent display 200. Sixth layer 212 is bonded to fourth layer 208. As with first layer 202, in some embodiments, fifth and sixth layers 210 and 212 are switched, such that the touch sensors are located behind (instead of in front of) fifth layer 210.

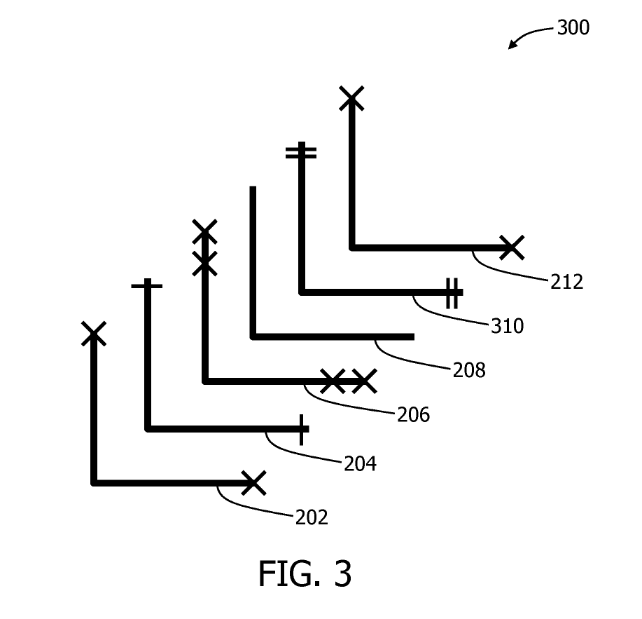

FIG. 3 is a schematic diagram of an alternative transparent display 300 for which content is viewable and interactive from both sides. Unless otherwise indicated, transparent display 300 is substantially similar to transparent display 200 (shown in FIG. 2). Specifically, in transparent display 300, the tinted glass or film of fifth layer 210 is replaced with a fifth layer 310 that is a substantially transparent (e.g., un-tinted) protective layer (e.g., glass or film).

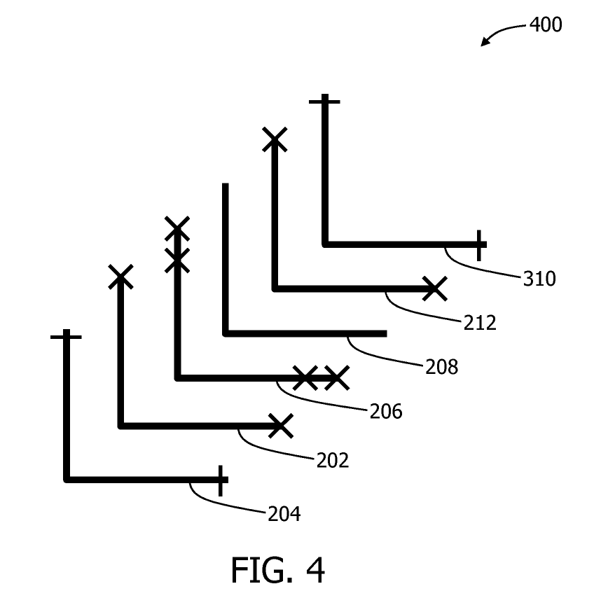

FIG. 4 is a schematic diagram of alternative transparent display 400 for which content is viewable and interactive from both sides. Unless otherwise indicated, transparent display 400 is substantially similar to transparent display 300 (shown in FIG. 3). Specifically, in transparent display 400, the positions of fifth layer 310 and sixth layer 212 are switched, and the positions of first layer 202 and second layer 204 are switched. Accordingly, the layers including touch sensors (i.e., first layer 202 and sixth layer 212) are located behind, or inwards of the respective protective layers (i.e., second layer 204 and fifth layer 310). First layer 202 and sixth layer 212 may be implemented, for example, using PCAP or silver nanowire technology.

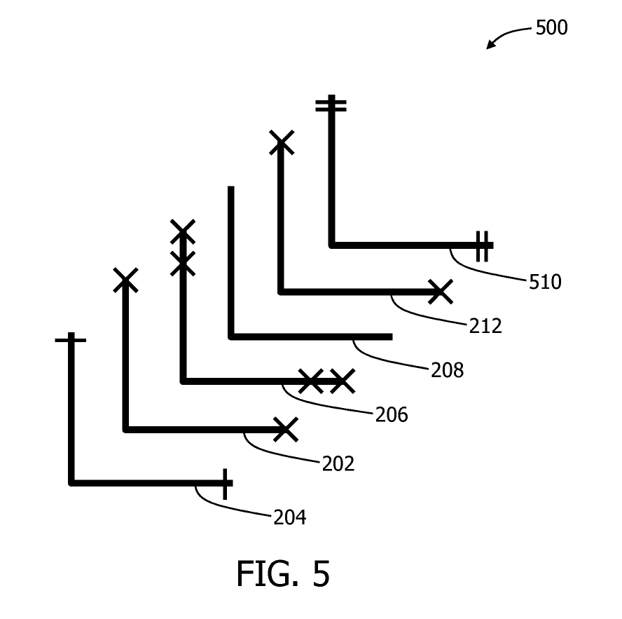

FIG. 5 is a schematic diagram of alternative transparent display 500 for which content is viewable and interactive from both sides. Unless otherwise indicated, transparent display 500 is substantially similar to transparent display 400 (shown in FIG. 5). Specifically, in transparent display 500, fifth layer 310 is replaced with a tinted layer 510. Tinted layer 510 may include a tinted glass or film, may have a grey or bronze tint, and may be tinted greater than or equal to 30% to enhance two-way visibility of transparent display 500 and reduce the perceived brightness of the light guide of fourth layer 208.

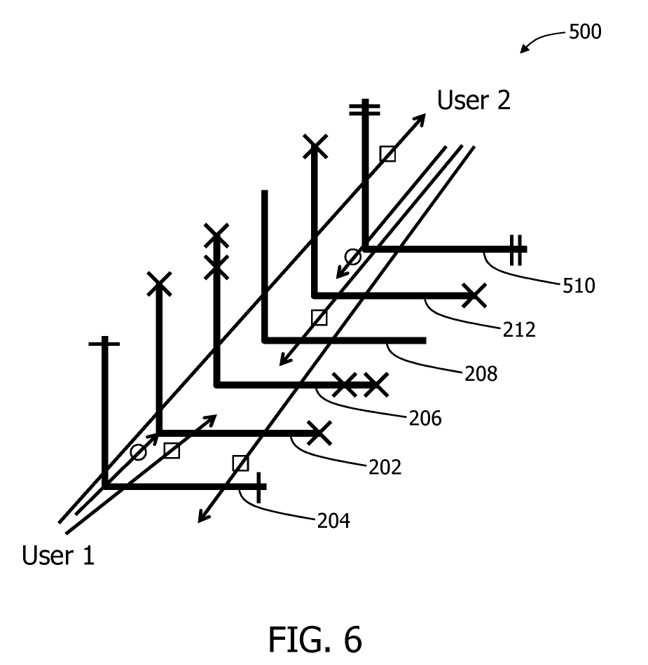

FIG. 6 is a schematic diagram illustrating visibility and touch capability for User 1 and User 2 on respective sides of transparent display 500. In FIG. 6, sightlines with circles represent touch capability and sightlines with squares represent visibility. Accordingly, as shown in FIG. 6, User 1 and User 2 can each view and interact with content shown on their own respective side, as well as content shown on the opposing side. Notably, the visibility and touch capability shown in FIG. 6 for transparent display 500 would also apply to transparent displays 200, 300, and 400.

In embodiments where users on opposite sides may both interact with the displayed content, the touch sensors on either side are calibrated using the same points of content, and may operate independently of one another (e.g., if only one touch screen is activated, the other need not have a user). Moreover, both touch screens can manipulate the same content, or one side may be selectively deactivated.

Further, in some embodiments, a light guide (e.g., fourth layer 208) may not be provided. For example, embodiments that use an OLED display panel may not include a light guide. The display devices may be used with gaming devices, as a communication device, or as a stand-alone device to execute a predetermined command on either side of the display device. For example, a user on one side of the display device may interact with (e.g., touch) the display device to tint the other side of the display device. In another example, a user may interact with the display device to turn on a display panel that functions as a television. For example, if the display device is implemented within a window, a user may be able to watch television on the “window” from the outside of the structure including the window without entering the structure. In another example, the display device may be implemented in a wall on a vehicle or vessel (e.g., naval vessels) to provide a physical barrier and allow users on either side to manipulate the displayed content. For example, in some embodiments, the display device is implemented in a visor, window, or windshield of an automobile.

In some embodiments, content may be visible from one side of a transparent display, but may not be visible from the opposite side of the transparent display. Such embodiments may include a privacy film on one or more surfaces.

For example, two display panels may be positioned in a “back to back” configuration and separated by a transparent light guide. The light guide effectively blocks content displayed on either display panel from being visible from the side of the other display panel. For example, a first user (“User 1”) facing the device would be able to see the content (“Content 1”) on the display panel nearest to him. In contrast, a second user (“User 2”) on the opposite side of the device would be able to see content nearest her (“Content 2”). The transparent light guide separating the two display panels filters out the visibility of the content furthest from each viewer, and may include a film coupled to a the light guide. Therefore, User 1 can see Content 1 and User 2, but cannot see Content 2. Similarly, User 2 can see Content 2 and User 1, but cannot see Content 1.

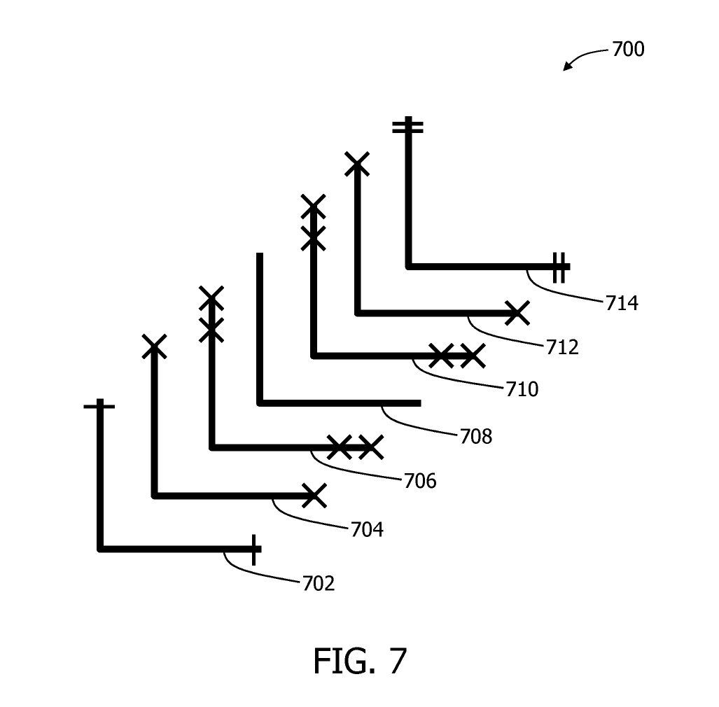

FIG. 7 is a schematic diagram of a two-way viewable transparent display 700 that includes separately viewable content from each side. That is, both the front and back of transparent display 700 each include a respective display panel. For clarity and simplicity, only the corner of each layer of transparent display 700 is shown in FIG. 7. However, those of skill in the art will appreciate that the layers of transparent display 700 will be complete panels, and may have any suitable shape (e.g., rectangular, circular, hexagonal, etc.).

Transparent display 700 includes a first layer 702 that is a protective layer. For example, first layer 702 may be a glass or film layer. A second layer 704 of transparent display 700 includes one or more touch sensors. In this embodiment, second layer 704 is implemented using PCAP or silver nanowire technology. Alternatively, second layer 704 may be implemented using other touchscreen technology (e.g., IR touch sensors, and/or surface light wave (SLW) technology). The touch sensors of second layer 704 may be affixed to first layer 702 using, for example, optical bonding or lamination.

Transparent display 700 includes a third layer 706 that functions as a display layer. Third layer 706 may be, for example, an LED OLED, AMOLED, QLED, QLCD, QOLED, TOLED, PMOLED, and/or QLED display. Alternatively, third layer 706 may be any suitable display technology that enables transparent display 700 to function as described herein. Third layer 706 may be attached to second layer 704 using, for example, optical bonding. Alternatively, third layer 706 may merely be positioned close to (e.g., within 3 millimeters (mm) of) second layer 704.

A fourth layer 708 of transparent display 700 is a transparent light guide in this embodiment. The transparent light guide may be, for example, a polymer. In some embodiments, the transparent light guide includes a light diffusing tape or film to ensure a uniform distribution of light. Fourth layer 708 may be closely positioned (e.g., within 3 mm) or optically bonded to third layer 706.

In this embodiment, bonded or disposed close to fourth layer 708 is a fifth layer 710 that functions as another display layer. Similar to third layer 706, fifth layer 710 may be, for example, an LED, OLED, AMOLED, QLED, QLCD, QOLED, TOLED, PMOLED, and/or QLED display. Further, fifth layer 710 may use the same or different technology as third layer 706.

A sixth layer 712 of transparent display 700 includes touch sensors, similar to second layer 704. Accordingly, second and sixth layers 704 and 712 provide touch sensors on both the front and back of transparent display 700. The touch sensors of sixth layer 712 may be affixed to a seventh layer 714 using, for example, optical bonding or lamination. In this embodiment, seventh layer 714 includes a tinted glass or film. For example, seventh layer 714 may have a grey or bronze tint, and may be tinted greater than or equal to 30% to enhance two-way visibility of transparent display 700 and reduce the perceived brightness of the light guide of fourth layer 708. The tinting is useful when the LEDs are bright enough to scatter light through the light guide, which may create an undesirable glow that may affect transparency.

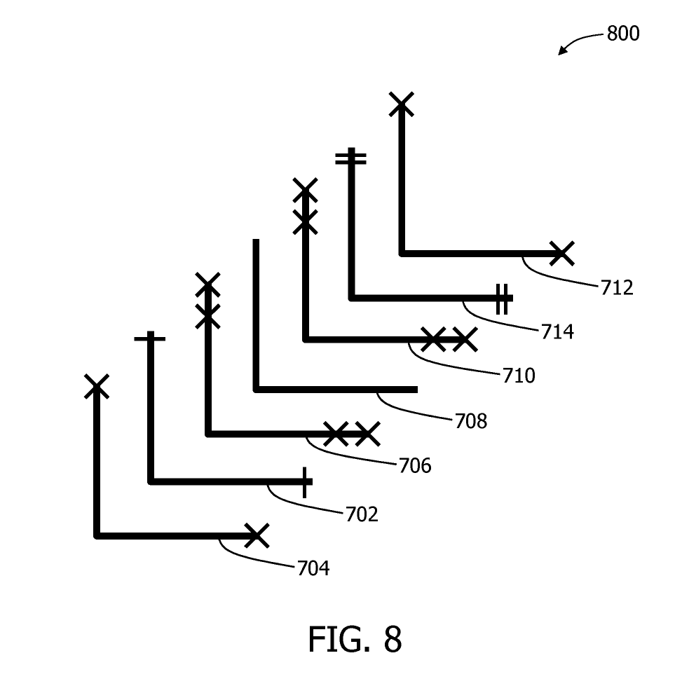

FIG. 8 is a schematic diagram of alternative transparent display 800 for which content is separately viewable from each side. Unless otherwise indicated, transparent display 800 is substantially similar to transparent display 700 (shown in FIG. 7). Specifically, in transparent display 800, the positions of first layer 702 and second layer 704 are switched, and the positions of sixth layer 712 and seventh layer 714 are switched. Accordingly, the layers including touch sensors (i.e., second layer 704 and sixth layer 712) are located in front of, or outwards of the respective protective layers (i.e., first layer 702 and seventh layer 714). Second layer 704 and sixth layer 712 may be implemented, for example, using IR touch sensors.

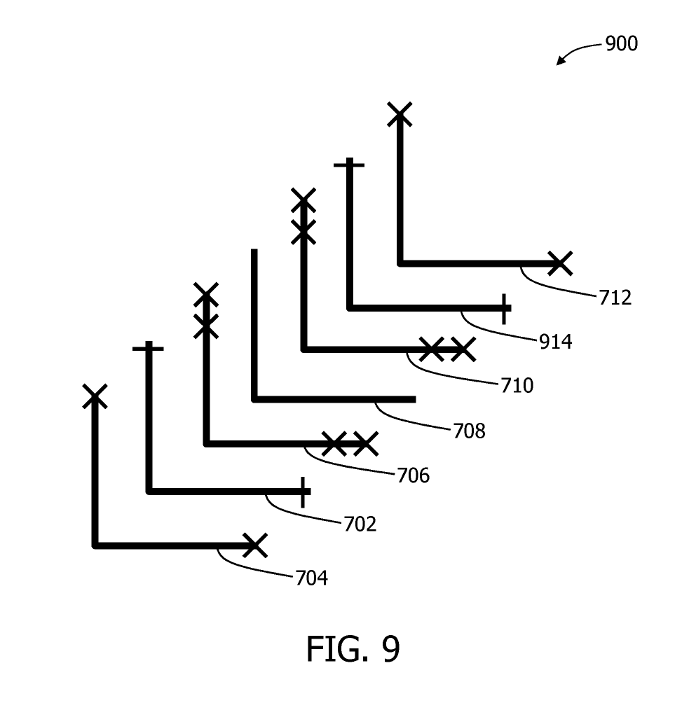

FIG. 9 is a schematic diagram of an alternative transparent display 900 for which content is viewable and interactive from both sides. Unless otherwise indicated, transparent display 900 is substantially similar to transparent display 800 (shown in FIG. 8). Specifically, in transparent display 900, the tinted glass or film of seventh layer 714 is replaced with a substantially transparent (e.g., un-tinted) protective layer 914 (e.g., glass or film).

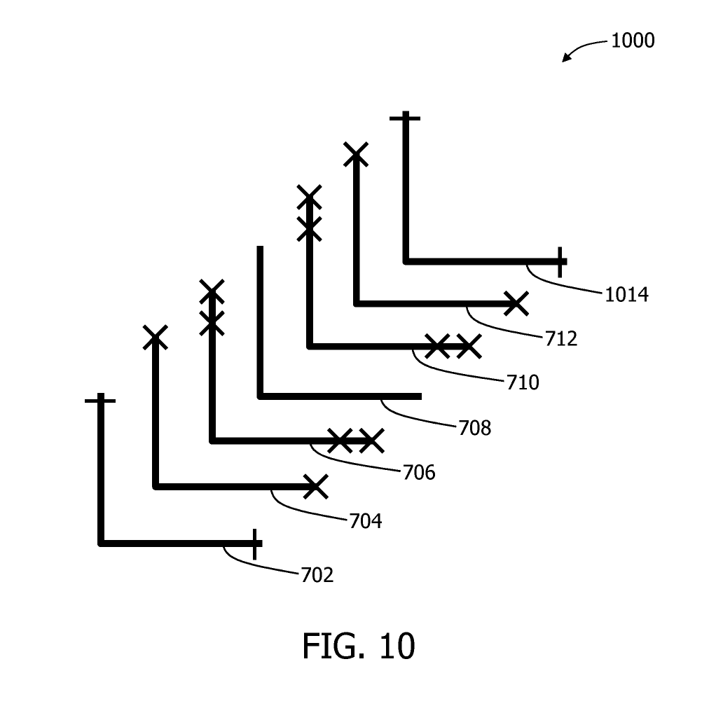

FIG. 10 is a schematic diagram of an alternative transparent display 1000 for which content is viewable and interactive from both sides. Unless otherwise indicated, transparent display 1000 is substantially similar to transparent display 700 (shown in FIG. 7). Specifically, in transparent display 1000, the tinted glass or film of seventh layer 714 is replaced with a substantially transparent (e.g., un-tinted) protective layer 1014 (e.g., glass or film).

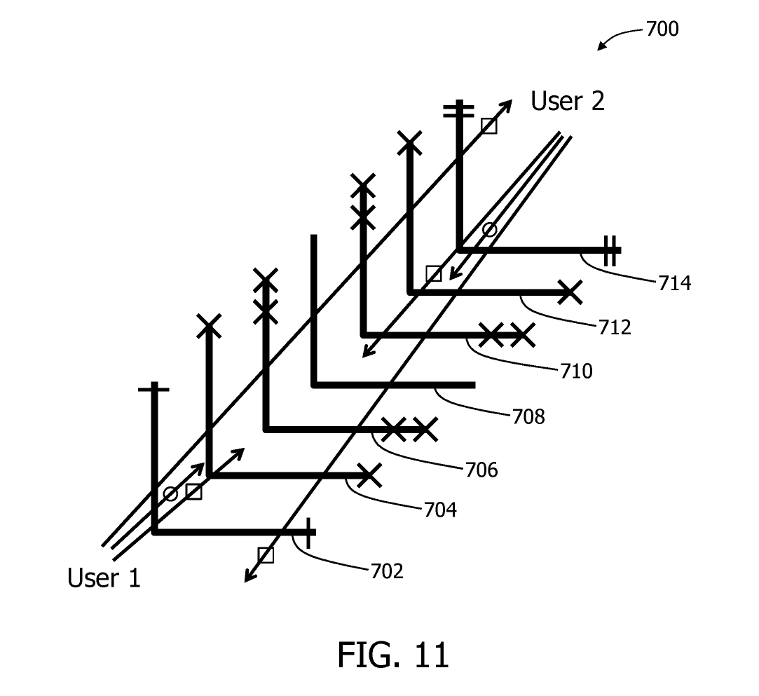

FIG. 11 is a schematic diagram illustrating visibility and touch capability for User 1 and User 2 on respective sides of transparent display 700 (shown in FIG. 7). In FIG. 11, sightlines with circles represent touch capability and sightlines with squares represent visibility. Accordingly, as shown in FIG. 11, User 1 and User 2 can each view and interact with content shown on their own respective side, and can view each other, but cannot view content shown on the opposing side. Notably, the visibility and touch capability shown in FIG. 11 for transparent display 700 would also apply to transparent displays 800, 900, and 1000.

In embodiments where users on opposite sides may each view separate content, the touch sensors on either side may be calibrated using the same points of content, and may operate independently of one another (e.g., if only one touch screen is activated, the other need not have a user). Moreover, both touch screens can manipulate the same content, or may manipulate different sets of content.

Further, in some embodiments, a light guide (e.g., fourth layer 708) may not be provided. For example, embodiments that use an OLED display panel may not include a light guide. The display devices may be used with gaming devices, as a communication device, or as a stand-alone device to execute a predetermined command on either side of the display device. For example, a user on one side of the display device may interact with (e.g., touch) the display device to tint the other side of the display device. In another example, a user may interact with the display device to turn on a display panel that functions as a television. For example, if the display device is implemented within a window, a user may be able to watch television on the “window” from the outside of the structure including the window without entering the structure. In another example, the display device may be implemented in a wall on a vehicle or vessel (e.g., naval vessels) to provide a physical barrier and allow users on either side to manipulate displayed content.

In another example, the display devices may be used in a store-front, where users on each side can view content on the display panel closest to them, but cannot view the content displayed on the far side. For example, a hotel could advertise on the external side of the display device (which may serve as a window), and simultaneously display television to viewers on the internal side of the display device.

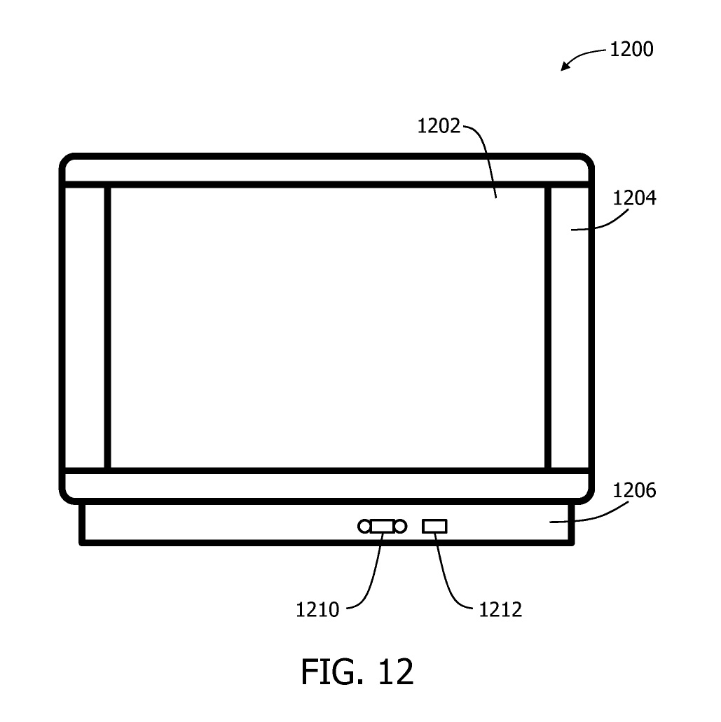

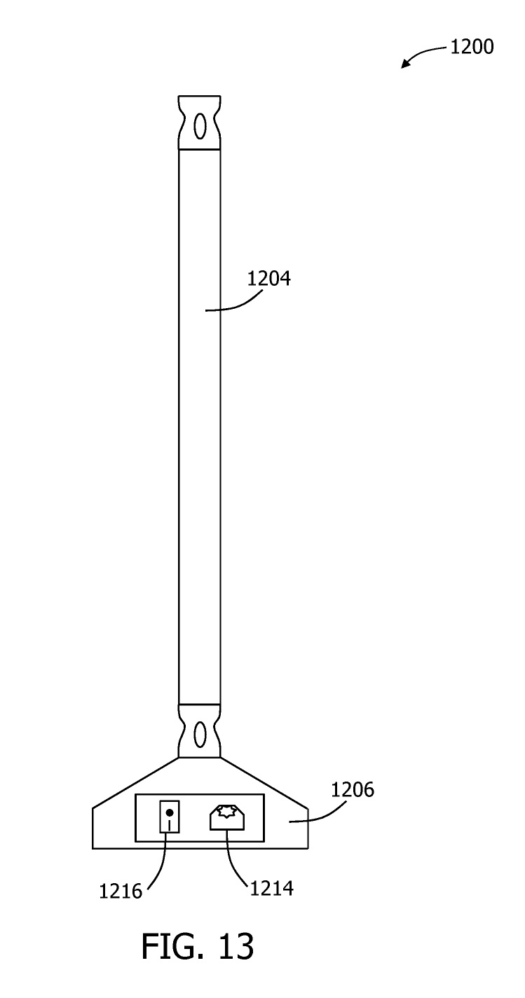

FIG. 12 is a front view of one of one embodiment of a transparent display system 1200. FIG. 13 is a side view of transparent display system 1200. System 1200 includes a transparent display 1202, which may be any of the transparent displays described herein. Transparent display 1202 is contained within a frame 1204, and frame 1204 is coupled to a base 1206. Base 1206 facilitates supporting frame 1204 and transparent display 1202. Base 1206 may include, for example, a USB input 1210, an HDMI input 1212, an AC power input 1214, and a power switch 1216 for selectively activating transparent display 1202.

In this embodiment, transparent display system 1200 is relatively thin. For example, frame 1204 may have a thickness of approximately 1 inch. Alternatively, transparent display system 1200 may have any suitable dimensions.

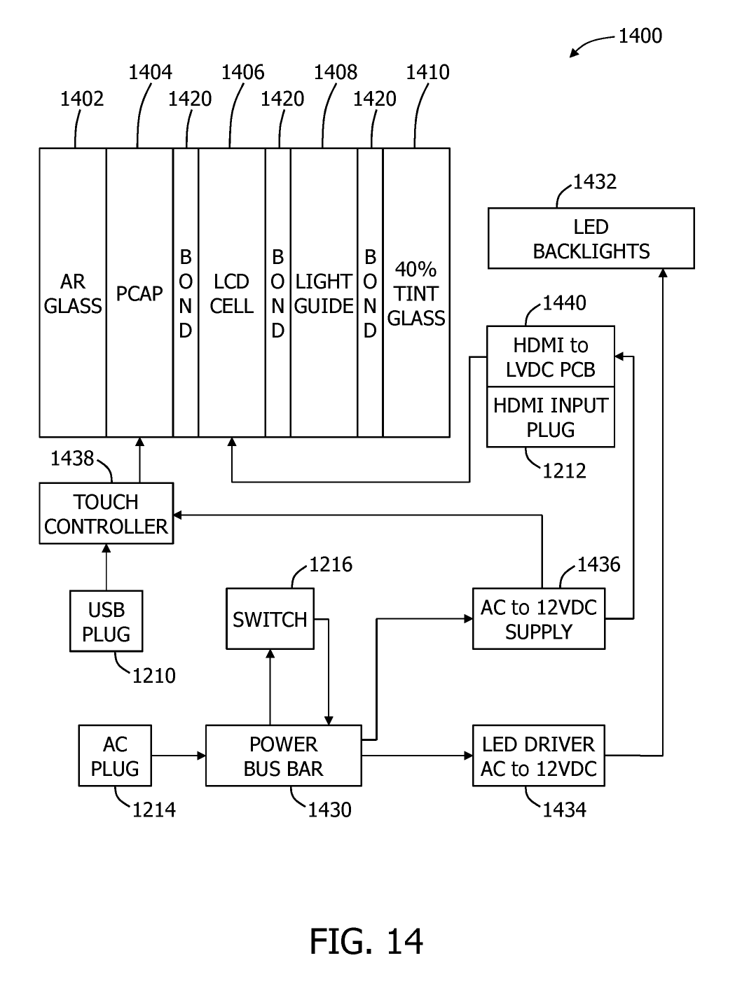

FIG. 14 is a block diagram of one embodiment of a system architecture 1400 of a transparent display system, such as transparent display system 1200 (shown in FIG. 12). In the embodiment shown in FIG. 14, transparent display 1202 includes, in series, a protective glass layer 1402, a PCAP touch screen layer 1404, an LCD display layer 1406, a light guide layer 1408, and a tinted glass layer 1410. Alternatively, transparent display 1202 may include any suitable layers, such as the configurations described in detail herein. A bonding material 1420 couples PCAP touch screen layer 1404 to LCD display layer 1406, couples LCD display layer 1406 to light guide layer 1408, and couples light guide layer 1408 to tinted glass layer 1410.

Power switch 1216 is coupled to a power bus bar 1430 that controls whether transparent display 1202 is powered on. Specifically, power bus bar 1430 powers LED backlights 1432 via an LED driver 1434 that converts AC input power to DC output power. Power bus bar 1430 also provides power to an AC to DC power supply 1436 that in turn provides DC power to a touch controller 1438. Touch controller 1438 controls operation of PCAP touch screen layer 1404. AC to DC power supply 1436 also supplies power to a printed circuit board 1440 that converts an HDMI signal into a low-voltage differential signaling signal for operating LCD display layer 1406.

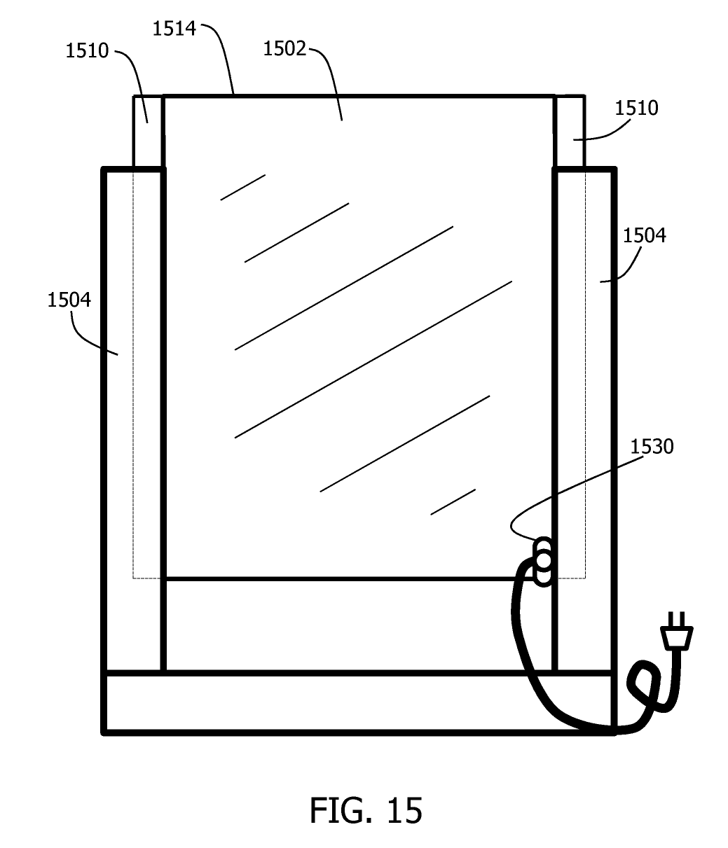

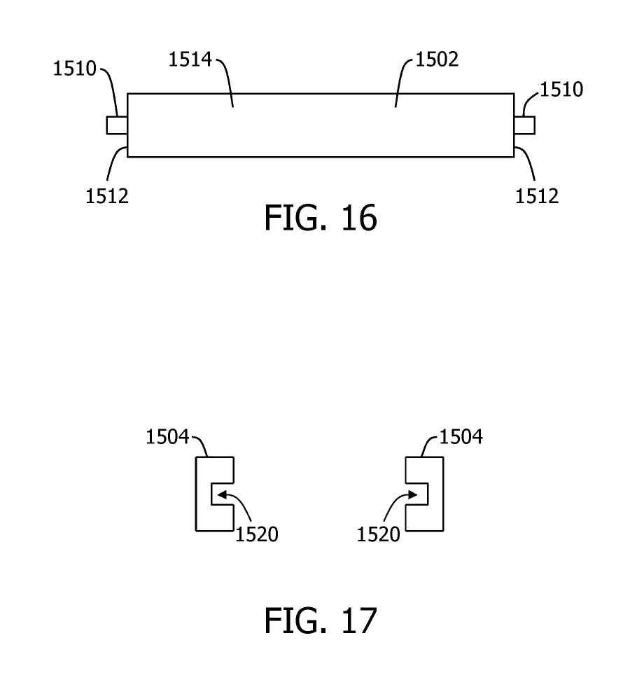

As described herein, the transparent displays disclosed herein may be installed in a window of a structure. FIG. 15 is a front view of one embodiment of a transparent display 1502 installed in window mullions 1504. FIG. 16 is a top view of transparent display 1502, and FIG. 17 is a top view of window mullions 1504.

As shown in FIGS. 15-17, transparent display 1502 includes a rail 1510 on each side 1512. In some embodiments, transparent display 1502 may additionally or alternatively include rails on a top 1514 and/or bottom 1516 of transparent display 1502. Rails 1510 may be insulated with rubber and/or other waterproof materials.

Each window mullion 1504 includes a slot 1520 sized and oriented to receive a corresponding rail 1510. Accordingly, as shown in FIG. 15, transparent display 1502 may be installed by engaging rails 1510 with corresponding slots 1520 and sliding transparent display 1502 in between window mullions 1504. Transparent display 1502 also includes a power input 1530 for providing power to transparent display 1502. Each rail 1510 and slot 1520 may have a thickness and depth of, for example, approximately 2 inches. Further, once installed, transparent display 1502 may be recessed relative to window mullions 1504 by approximately 1 to 3 inches. Alternatively, rails 1510, slots 1520, and transparent display 1502 may have any suitable dimensions.

In some embodiments, the display panels and light guides described herein may be flexible and/or foldable. Further, the display technologies used herein may be referred to as “a liquid crystal display”, “a thin film transistor liquid crystal display”, “an organic light-emitting diode display”, and/or “a flexible display.” Further, although described in the content of two-dimensional displays, three-dimensional display devices are also contemplated by the disclosure.

In some embodiments, the display devices include a light-absorbing film or layer. The light-absorbing film or layer may include a plurality of microscopic glass beads that capture and reflect light emanating from the light guide panel, and redirect the reflected light towards the display panel. The light-absorbing film or layer may also capture the light such that the light is concentrated in each microbead and exits the microbead at only one point. The light-absorbing film or layer may replace a layer of tinted material, and one or more protective layers may be used to protect the light-absorbing film or layer from scratches.

In the embodiments described herein, a coating, film, and/or thin material including microbeads may be applied to the outermost back and front layers of the display device. This facilitates minimizing an amount of light exiting from the light guide panel, and from the display panel itself. For one-way viewable displays, the coating, film, and/or thin material may be positioned directly behind and/or affixed to the light guide panel (i.e., on the surface of the light guide panel opposite the viewer and the display panel). For two-way viewable displays, the coating, film, and/or material may be placed on one or both sides of the light guide panel to brighten the image on the display panel.

The display devices may be implemented as all or part of a window, a door, and/or a display device for another electronic system (e.g., a mobile communication device). In some embodiments, the display devices may be used in flexible displays where a film or bendable polymer is used instead of a panel made of glass or another rigid material. Further, the display devices described herein may include touch screen devices or assemblies, including but not limited to IR touch sensors, PCAP or silver nanowire technology, and/or SLW technology, among others.

Users may interact with the transparent display using methods other than touchscreen technology. For example, in some embodiments, the transparent display includes a near field communication (NFC) module capable of communicating with a portable device, such as a mobile communications device (e.g., a smartphone). For example, a user may communicate with the transparent display via NFC using the portable device to change content displayed on the transparent display and/or facilitate purchasing additional content or goods using the transparent display.

Although certain embodiments of this disclosure have been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the disclosure. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the disclosure as defined in the appended claims.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the disclosure, it is intended that all matter contained in the above description or shown in the accompanying drawings shall be interpreted as illustrative and not in a limiting sense.

What is claimed is:

1. A transparent display comprising:
a first layer comprising a display module;
a second layer comprising a light guide panel configured to transmit light through the display module to generate viewable content; and
a third layer comprising a tinted material, wherein the second layer is positioned between the first layer and the third layer, and wherein the tinted material enables a user to view the viewable content when looking through the third layer toward the first and second layers.

2. A transparent display in accordance with claim 1, wherein the first layer comprises at least one of a light-emitting diode display, and organic light-emitting diode display, an active matrix organic light-emitting diode display, a quantum dot light-emitting diode display, a quantum liquid crystal display, a quantum organic light-emitting diode display, a transparent organic light-emitting diodes diode display, and a passive matrix organic light-emitting diode display.

3. A transparent display in accordance with claim 1, further comprising a fourth layer including at least one first touch sensor, the fourth layer positioned on a first side of the first layer.

4. A transparent display in accordance with claim 3, further comprising a fifth layer including at least one second touch sensor, the fifth layer located on a second side of the first layer, wherein the second side is opposite the first side.

5. A transparent display in accordance with claim 3, wherein the at least one first touch sensor includes at least one of an infrared touch sensor, a projected capacitive touch sensor, a silver nanowire touch sensor, and a surface light wave touch sensor.

6. A transparent display in accordance with claim 1, further comprising a fourth layer comprising an additional display module.

7. A transparent display in accordance with claim 1, further comprising a light-absorbing layer affixed to said second layer, wherein said light-absorbing layer includes a plurality of microscopic glass beads.

8. A transparent display system comprising:
a transparent display comprising:
a first layer comprising a display module;
a second layer comprising a light guide panel configured to transmit light through the display module to generate viewable content; and
a third layer comprising a tinted material, wherein the second layer is positioned between the first layer and the third layer, and wherein the tinted material enables a user to view the viewable content when looking through the third layer toward the first and second layers;
a frame housing the transparent display; and
a base coupled to and supporting the frame.

9. A transparent display system in accordance with claim 8, wherein the first layer comprises at least one of a light-emitting diode display, and organic light-emitting diode display, an active matrix organic light-emitting diode display, a quantum dot light-emitting diode display, a quantum liquid crystal display, a quantum organic light-emitting diode display, a transparent organic light-emitting diodes diode display, and a passive matrix organic light-emitting diode display.

10. A transparent display system in accordance with claim 8, further comprising a fourth layer including at least one first touch sensor, the fourth layer positioned on a first side of the first layer.

11. A transparent display system in accordance with claim 10, further comprising a fifth layer including at least one second touch sensor, the fifth layer located on a second side of the first layer, wherein the second side is opposite the first side.

12. A transparent display system in accordance with claim 10, wherein the at least one first touch sensor includes at least one of an infrared touch sensor, a projected capacitive touch sensor, a silver nanowire touch sensor, and a surface light wave touch sensor.

13. A transparent display system in accordance with claim 8, further comprising a fourth layer comprising an additional display module.

14. A transparent display system in accordance with claim 8, wherein the third layer includes at least 30% tinting.

15. A method of assembling a transparent display, the method comprising:
coupling a first layer to a second layer, wherein the first layer includes a display module, and wherein the second layer includes a light guide panel configured to transmit light through the display module to generate viewable content; and
positioning a third layer relative to the second layer such that the second layer is positioned between the first and third layers, wherein the third layer includes a tinted material, and wherein the tinted material enables a user to view the viewable content when looking through the third layer toward the first and second layers.

16. A method in accordance with claim 15, wherein the transparent display includes at least one rail, the method further comprising installing the transparent display by inserting the at least one rail into a corresponding slot defined in a window mullion.

17. A method in accordance with claim 15, further comprising coupling a fourth layer to the second layer, wherein the fourth layer includes an additional display module.

18. A method in accordance with claim 15, wherein coupling a first layer comprises coupling a first layer that includes at least one of a light-emitting diode display, and organic light-emitting diode display, an active matrix organic light-emitting diode display, a quantum dot light-emitting diode display, a quantum liquid crystal display, a quantum organic light-emitting diode display, a transparent organic light-emitting diodes diode display, and a passive matrix organic light-emitting diode display.

19. A method in accordance with claim 15, further comprising positioning a fourth layer on a first side of the first layer, the fourth layer including at least one first touch sensor.

20. A method in accordance with claim 19, further comprising positioning a fifth layer on a second side of the first layer, the fifth layer including at least one second touch sensor, wherein the second side is opposite the first side.
